(19) United States
(12) Patent Application Publication
(10) Pub. No.: US 2005/0266208 A1
(43) Pub. Date: Dec. 1, 2005

(54) Abrasion-resistant, antistatic, antireflective transparent coating and method for making it

(75) Inventors: Satyabrata Raychaudhuri, Thousand Oaks, CA (US); Yongan Yan, Thousand Oaks, CA (US); Chorng-Jeou Chen, Westlake Village, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(73) Assignee: Yazaki Corporation

(21) Appl. No.: 10/853,877

(22) Filed: May 25, 2004

(51) Int. Cl. B32B 1/00

(52) U.S. Cl. 428/143

(57) ABSTRACT

An improved abrasion-resistant, antistatic, antireflective transparent coating, and a method for making it, are described. The coating includes a hard coat underlayer and an antistatic, antireflective overlayer, wherein the overlayer consists essentially of hydrolyzed silica and silica particles having a size less than 1000 nm and a concentration in the range of 0.00015 to 0.01 mg/cm². The antistatic, antireflective overlayer is made using a sol-gel method including steps of (1) preparing a sol-gel solution comprising a hydrolyzed organo-metallic compound of silicon and silica particles, (2) modifying the outer surface of the hard coat layer, (3) depositing the sol-gel solution onto the modified outer surface of the hard coat layer, and (4) thermally treating the article in an atmosphere having a controlled humidity, wherein the partial pressure of the water, P_{H}_{₂}_{O}, expressed in units of kPa, satisfies the following inequality:
P_{H}_{₂}_{O}≧0.09+0.05T where T is temperature, in degrees C.

### BACKGROUND OF THE INVENTION

This invention relates generally to abrasion-resistant, antistatic, antireflective transparent coatings suitable for use in cover plates for displays and optical articles. The invention relates more particularly to such coatings suitable for transparent articles and to methods for making such coatings.

Transparent cover plates for displays such as liquid crystal displays (LCDs), plasma display panels (PDPs), cathode ray tubes (CRTs), and other transparent optical articles such as eyeglasses, generally are made of dielectric materials such as plastics, glasses, or ceramics. These transparent dielectric materials can store electrostatic charge as a result of handling, rubbing, cleaning, or the application of high voltages. The electrostatic charge can cause a collection of dust on the cover plates and optical materials, reducing the light transmittance and increasing the light scattering, thereby distorting the image. The electrostatic charge also can cause sparks, which sometimes can damage the electronic circuits of the displays.

To overcome such problems, these optical articles typically are coated with antistatic coatings. The antistatic coatings can be made by depositing semi-conducting or conducting materials as thin films onto the articles using vapor deposition techniques such as sputtering, chemical vapor deposition, or like. However, such techniques require expensive equipment, including vacuum chambers and an expensive manufacturing environment. Consequently, liquid deposition techniques, including sol-gel processes, have been utilized to decrease the cost of depositing antistatic coatings.

Antistatic coatings made by liquid deposition techniques usually incorporate electrically semi-conducting or conducting materials into a non-conductive transparent matrix, to obtain the antistatic property. Examples of the semi-conducting or conducting materials used for this purpose are tin oxide, indium oxide, antimony oxide, indium-doped tin oxide (ITO), antimony-doped tin oxide (ATO), and metal salts. Particles of metals such as copper, gold, silver, and nickel also can be incorporated into the non-conductive transparent matrix, to provide coatings having low surface electrical resistivity. The use of electrically conductive polymers and carbon black particles also has been described. These semi-conducting or conducting materials generally are semi-transparent or even opaque. Therefore, the semi-conducting or conducting materials are dispersed into a transparent matrix in quantities and particle sizes sufficient to dissipate the electrostatic charge without causing considerable reduction in transmitted light. The transparent matrixes comprise organic polymers such as acrylates, inorganic materials such as silica, or hybrid inorganic-organic materials such as polysiloxanes.

The optical articles also frequently are coated with antireflective coatings, to decrease the level of reflected light and thereby increase image contrast and visibility and minimize eye fatigue. Such antireflective coatings typically are comprised at least one layer. Multilayer antireflective coatings comprising alternating high- and low-refractive index layers also have been proposed, to further decrease the level of the reflected light.

The collection of dust and the reflection of incident light both can be prevented by providing a coating having both antistatic and antireflective property. Japan Publication No. 61-118932 to Kawamura et al. discloses the deposition of a single layer, antistatic, antireflective silica coating onto the outer surface of a CRT, by first spraying onto the surface a sol-gel solution prepared by mixing a silicon alkoxide (Si(OC₂H₅)₄) in an ethanol solvent (C₂H₅OH), with a nitric acid catalyst (HNO₃), and then heat-treating the sprayed film at a low temperature, for example 80° C. for 30 minutes, to sinter the film. The spraying provides a surface roughness sufficient to diffuse the reflected light away from the observer. An antireflective property thereby is obtained through such non-glare effect.

Japan Publication No. 61-118946 to Morikawa et al. explains that the antistatic property of this coating is obtained through a silanol (i.e., Si—OH) layer formed on the coating's surface. Similarly, U.S. Pat. No. 4,873,120 to Itou et al. describes an antistatic, antireflective silica coating produced using a sol-gel solution composed of a polyalkyl siloxane, water, isopropanol (i-C₃H₇OH), and nitric acid (HNO₃). The sol-gel solution is deposited onto the outer surface of a CRT by spraying. A silanol group is said to be formed on the coating's surface, to provide the antistatic property.

Although such silica coatings deposited from sol-gel solutions were initially thought to be promising for manufacturing antistatic, antireflective coatings for the cover plates of displays, it was later found that these coatings can lose their antistatic properties over time. It also was later found that these coatings can sometimes have low mechanical strength and poor adhesion to the cover plates.

U.S. Pat. No. 4,987,338 to Itou et al. explains that silica coatings deposited from sol-gel solutions can lose their antistatic properties over time. Itou et al. prepare a sol-gel solution from ethyl silicate, water, i-C₃H₇OH, and hydrochloric acid (HCl), and then deposit this solution onto the surface of a CRT by spin coating. In Embodiment 1 of the patent, the surface resistance of the coating increased from 5×10⁹ ohm-cm to 1×10¹³ ohm-cm, after the coating was maintained at 80° C. for 500 hours. This result indicates that the silica coatings described in Japan Publication No. 61-118932 to Kawamura et al., Japan Publication No. 61-118946 to Morikawa et al., and U.S. Pat. No. 4,873,120 to Itou et al. do not have an antistatic property and thereby are not suitable for providing antistatic property to the transparent articles.

U.S. Pat. No. RE 37,183 to Kawamura et al. discloses that sintering the silica coatings above 80° C. converts the silanol groups to siloxane (i.e., Si—O—Si—) groups, thereby decreasing the coating's antistatic properties. The patent also discloses that the coatings formed at such low temperatures exhibit very low mechanical strengths and poor adhesion to the surface of the cover plates. In a comparative example set forth in U.S. Pat. No. RE 37,183, a silica coating is deposited by spin coating sol-gel solution consisting essentially of a silicon alkoxide (Si(OC₂H₅)₄), fine silica particles, ethanol (C₂H₅OH), acetyl acetone, and nitric acid HNO₃, and then sintering the coating at 150° C. for about 30 minutes. It was found that, for this coating, the time period for the potential decay to 1 kV after the switch-off is longer than 200 seconds, and the surface resistivity is 1×10¹² ohm/square (Ω/□). This result indicates that, although this coating might have acceptable mechanical strength, it does not have an antistatic property and thereby is not suitable for providing desired antistatic property to the transparent articles.

The electrically semi-conducting and conducting materials, therefore, have been incorporated into silica matrices to obtain coatings having the desired antistatic properties. For example, U.S. Pat. No. RE 37,183 indicates that it is essential to incorporate tin oxide, indium oxide, antimony oxide, chlorides, nitrates, sulfates, and carboxylates of metals of groups II and III of the periodic table, with a silica matrix to obtain the antistatic properties required by the display industry. Similarly, U.S. Pat. No. 4,987,338 indicates that coatings incorporating organic dyes into the silica matrix yield the desired antistatic property. The patent also discloses coatings incorporating salts of metals such as lithium, barium, strontium, and calcium as moisture absorbents to improve the antistatic property.

Incorporation of such electrically semi-conducting or conducting materials into the coatings increases the complexity of the processing and the production cost of the transparent articles. Furthermore, because some of these materials are not essentially transparent, they can decrease light transmittance, defeating the purpose of providing an image with better contrast and visibility. Also, although some of these materials, such as indium-tin oxide and antimony-tin oxide, are optically transparent, they increase the refractive index of the coating above that of the article, thereby increasing the level of reflected light. When the coatings are doped with such electrically conducting transparent materials, an additional antireflective layer must be deposited on the antistatic layer to provide antireflective property to the article, which significantly increases the manufacturing cost. This coating configuration is schematically shown in FIG. 1. This further complicates the depositing of antistatic coatings.

It should be appreciated from the foregoing description that there remains a need for an inexpensive antistatic, antireflective coating for the transparent cover plates of displays and optical articles. The present invention fulfills this need and provides further advantages.

### SUMMARY OF THE INVENTION

The present invention is embodied in an abrasion-resistant, antistatic, antireflective coating for a transparent article, comprising a hard coat layer and an overlaying antistatic, antireflective layer, wherein the antistatic, antireflective layer consists essentially of hydrolyzed silica and silica particles having a size less than 1000 nm and a concentration in the range of 0.00015 to 0.01 mg/cm², and wherein the antistatic, antireflective layer is deposited onto the hard coat layer using a sol-gel method. The sol-gel method comprises steps of preparing a sol-gel solution comprising a hydrolyzed organo-metallic compound of silicon and silica particles, modifying the outer surface of the hard coat layer, depositing the sol-gel solution onto the modified outer surface of the hard coat layer, and thermally treating the article in an atmosphere having a controlled humidity, wherein the partial pressure of the water, PH_{2O}, satisfies the following inequality:
P_{H}_{₂}_{O}≧0.09+0.05T
where: PH_{2O}is expressed in units of kPa, and
T is temperature, in degrees C.

In optional, more detailed features of the invention, the coating's hard coat layer has a thickness in the range of 1 to 10 micrometers. The hard coat layer has an abrasion resistance that preferably is less than 10 percent haze gain, and more preferably less than 7 percent, as measured by a Taber test after 100 cycles. The coating can further comprise a primer layer interposed between the surface of the article and the hard coat layer.

In other optional, more detailed features of the invention, the silica particles included in the antistatic, antireflective layer have a size preferably in the range of 5 and 1000 nm, and more preferably in the range of 10 to 100 nm, and have a concentration preferably in the range of 0.00015 to 0.002 mg/cm², and more preferably in the range of 0.0002 to 0.001 mg/cm².

In other optional, more detailed features of the invention, the organo-metallic compound included in the sol-gel solution comprises tetrafunctional silanes. Preferably the compound is selected from the group consisting of tetramethyl orthosilicate, tetraethyl orthosilicate, tetrapropyl orthosilicate, tetraisopropyl orthosilicate, and mixtures thereof, and most preferably the compound comprises tetraethyl orthosilicate. The sol-gel solution further can comprise water and/or a catalyst selected from the group consisting of hydrochloric acid, nitric acid, sulfuric acid, acetic acid, hydrofluoric acid, and mixtures thereof, and most preferably hydrochloric acid. Further the sol-gel solution can further comprise a solvent selected from the group consisting of alcohols, glycols, ethers, glycol ethers, ketones, esters, and glycolether acetates, and more preferably a solvent selected from the group consisting of methanol, ethanol, iso-propanol, and mixtures thereof.

In yet other optional, more detailed features of the invention, the sol-gel solution comprises 1 mole of the organo-metallic compound, 2 to 6 moles of the water, 0.05 to 1.0 moles of the catalyst, 10 to 110 moles of the solvent, and the silica particles. More particularly, the solution comprises 1 mole of the organo-metallic compound, 2 to 5 moles of the water, 0.1 to 0.3 moles of the catalyst, 20 to 40 moles of the solvent, and the silica particles.

In a separate aspect of the invention, the abrasion-resistant, antistatic, antireflective coating is deposited onto the transparent article by a method that includes steps of (1) depositing a hard coat layer onto the surface of the transparent article, (2) modifying the outer surface of the hard coat by corona discharge or chemical etching, and (3) forming an antistatic, antireflective layer on the modified hard coat layer, wherein the antistatic, antireflective layer consists essentially of hydrolyzed silica and silica particles having a size less than 1000 nm and a concentration in the range of 0.00015 to 0.01 mg/cm², and wherein forming includes steps of (a) preparing a sol-gel solution comprising a hydrolyzed organo-metallic compound of silicon and silica particles, (b) depositing the sol-gel solution onto the modified outer surface of the hard coat layer, and (c) thermally treating the article in an atmosphere having a controlled humidity, wherein the partial pressure of the water, PH_{2O}, expressed in units of kPa, satisfies the following inequality:
P_{H}_{₂}_{O}≧0.09+0.05T
where: PH_{2O}is expressed in units of kPa, and
T is temperature, in degrees C.

In optional, more detailed features of the invention, the outer surface of the hard coat layer modified by chemical etching using a solution of NaOH and/or KOH with water. In addition, the sol-gel solution is deposited onto the modified hard coat layer by a dip-coating method comprising steps of submerging the article in the sol-gel solution, and withdrawing the article at a predetermined withdrawal speed, preferably less than 1.0 cm/second, and more preferably less than 0.25 cm/second.

In other optional, more detailed features of the invention, the antistatic, antireflective layer is dried at ambient conditions for less than 30 minutes before the step of thermally treating. In addition, the step of thermally treating further comprises (1) placing the article in an oven maintained at a temperature in the range of 15° C. to 30° C., (2) heating the oven to the thermal treatment temperature at a heating rate less than 15° C./minute, (3) maintaining the oven at the thermal treatment temperature for a predetermined time period, and (4) cooling the oven to a temperature in the range of 15 to 30° C., at a cooling rate of about 15° C./minute.

In other optional, more detailed features of the invention, the step of thermally treating further comprises steps of (1) thermally treating the article in an oven at a predetermined thermal treatment temperature, for a predetermined thermal treatment time, and (2) introducing the controlled humidity atmosphere at any time during the step of thermally treating and continuing this introduction for a predetermined time period sufficient to provide the antistatic property to the article. The thermal treatment temperature preferably is in the range of 80 to 200° C., more preferably is in the range of 100 to 140° C., and most preferably is about 120° C. Further, the thermal treatment time preferably is in the range of 10 minutes to 10 hours, more preferably is in the range of 1 to 4 hours, and most preferably is about 2 hours.

In yet other optional, more detailed features of the invention, the step of thermally treating is a two-step process that includes steps of (1) initially thermally treating the article in an oven at a first predetermined thermal treatment temperature, for a predetermined first thermal treatment time period, with no controlled humidity atmosphere, and (2) subsequently thermally treating the article in an oven at a predetermined second thermal treatment temperature, and introducing the humid atmosphere at any time during such subsequent thermal treatment and continuing such introduction for a predetermined time period sufficient to provide the antistatic property to the article.

In this optional two-step thermal treatment process, the first thermal treatment temperature preferably is in the range of 80 to 200° C., more preferably is in the range of 100 to 140° C., and most preferably is about 120° C. The first thermal treatment time period preferably is in the range of 10 minutes to 10 hours, more preferably is in the range of 1 to 4 hours, and most preferably is about hours. Further, the second thermal treatment temperature preferably is in the range of 15 to 140° C. and more preferably is in the range of 20 to 120° C.

Other features and advantages of the present invention should become apparent from the following description of the preferred embodiments and method, taken in conjunction with the accompanying drawings, which illustrate, by way of example, the principles of the invention.

### BRIEF DESCRIPTION OF THE DRAWINGS

FIG. 1 is a schematic cross-sectional diagram of a prior art coating on a transparent article.

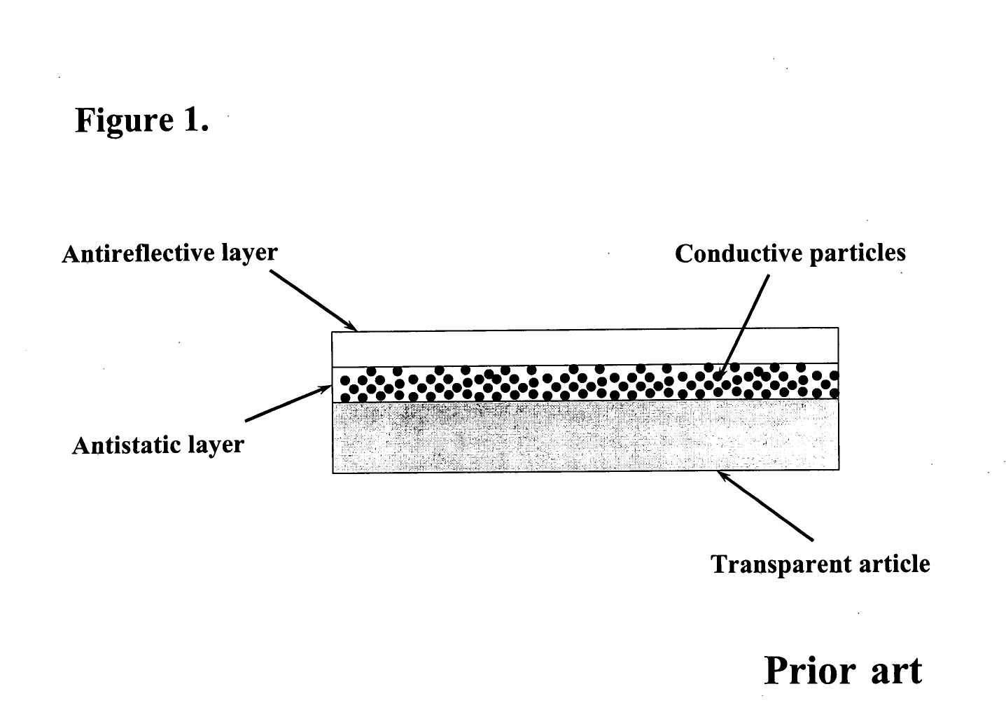

FIG. 2 is a schematic cross-sectional diagram of a first embodiment of a transparent coating in accordance with the present invention.

FIG. 3 is a schematic cross-sectional diagram of a second embodiment of a transparent coating in accordance with the present invention, this coating incorporating a primer layer to improve adhesion of the hard coat layer to the transparent article.

FIG. 4 is a graphical representation of the relationship between the level of reflected light and the wavelength of the incident light of the abrasion-resistant, antistatic, antireflective coating of the present invention.

### DETAILED DESCRIPTION OF THE PREFERRED EMBODIMENTS

This invention relates generally to abrasion resistant antistatic antireflective transparent coatings suitable for use in coating the cover plates of displays and other optical articles. This invention also relates to methods of making such transparent coatings.

These articles comprise cover plates of display devices such as field emission displays, liquid crystal displays (LCDs), plasma display panels (PDPs), electroluminescence displays (ELDs), cathode ray tube displays (CRTs), fluorescence tube displays, meters, clocks, and the like, used in the manufacture of televisions, personal digital assistants (PDAs), cellular phones, vehicle dashboards, projection screens, hand-held games and the like. Optical articles such as eyeglasses, lenses, prisms, optical windows, photomask substrates, pellicles used in photomask assemblies, and the like also can be coated with the coatings of the invention, to provide abrasion-resistant, antistatic, antireflective properties.

The articles being coated can have simple rectangular and flat shapes or can have complicated shapes with curvatures and bends. The articles can be made of polymers, glasses, ceramics, or hybrids of these materials. The polymeric articles can comprise poly(methyl methacrylate) (PMMA), polycarbonate (PC), poly(ethylene terephthalate) (PET), polystyrene, poly(diethylene glycol-bis-allyl carbonate) (ADC) or CR-39®, triacetyl cellulose (TAC), poly (ethylene-2,6-naphthalate) (PEN), or like.

The antistatic antireflective coating is deposited onto at least one surface of the article. The coating comprises at least two layers: an inner layer that functions to provide abrasion resistance, and an outer later that functions to provide both antistatic and antireflective properties. The inner layer is referred to below as a hard coat layer, and the outer layer is referred to below as an antistatic, antireflective layer.

Static is a surface property of a material, and it is determined by measuring the static decay time, expressed in seconds (s), and surface resistivity, expressed in ohms (O) or popularly expressed in ohms/square (Ω/□), where the size of the square is immaterial. The Electronic Industries Association standard (EIA-541) for antistatic (or static dissipative) materials states that, to have the antistatic property, a material's surface resistivity should be less than 10¹² Ω/□, and/or the time period for a 99 percent decay of the static charge (or static decay time) should be less than 2.0 seconds. The antistatic, antireflective layer described below achieves both of these antistatic property requirements.

Principles of providing coatings with antireflective properties are described in a publication entitled “Antireflection Coatings Made by Sol-Gel Processes,” Solar Energy Materials and Solar Cells, Volume 68 (2001), pages 313 to 336, by Dinguo Chen. Two basic approaches to achieve low reflection are described. In one approach, the exposed surface of an outer layer is roughened by etching, grinding, embossing, or like, or by incorporating particles into the transparent matrix. This provides haze, or diffuse reflection, and thereby reduces the reflection level. Coatings obtained by this approach are commonly referred as antiglare coatings. In the other approach, the refractive indices and thicknesses of a series of coating layers are controlled to provide destructive interference of the light reflected at the interfaces between the successive layers and the article.

Antiglare coatings prepared by etching, grinding, embossing, or like, generally have lower mechanical strength and abrasion resistance than do antiglare coatings prepared by incorporating particles into the coating matrix. The antiglare approach is advantageous, because the reflection levels of such coatings are less dependent on the wavelength of the incident light and because the control of the thicknesses and refractive indices of the coating's layers is relatively less critical.

On the other hand, the destructive interference approach provides clearer coatings, with comparatively lower antireflection levels. However, the reflection level of such coatings is more dependent on the wavelength of the incident light. Although the effect of this wavelength dependence can be decreased by having multiple destructive interference layers, the manufacturing cost of the coating increases with each additional layer. Furthermore, the control of the thicknesses and refractive indices is relatively more critical for the destructive interference type antireflective coatings.

Thus, both approaches have relative advantages and disadvantages. The choice between the two approaches depends on desired antistatic antireflective property level and cost requirements of a specific application. Both approaches, and a combination of the approaches, are within the scope of this invention.

The antistatic, antireflective layer of the invention comprises essentially hydrolyzed silica deposited from a sol-gel solution. This solution is prepared by reacting at least one hydrolyzable organo-metallic compound of silicon with water and by adding silica particles. Surprisingly, it has been found that the layer deposited from this simple inexpensive solution provides a antistatic property to the article and reduces the surface resistivity below 10¹² Ω/□ and static decay time below 2.0 seconds. This hydrolyzed silica layer also provides antireflective property with reduced wavelength dependency to the reflected light.

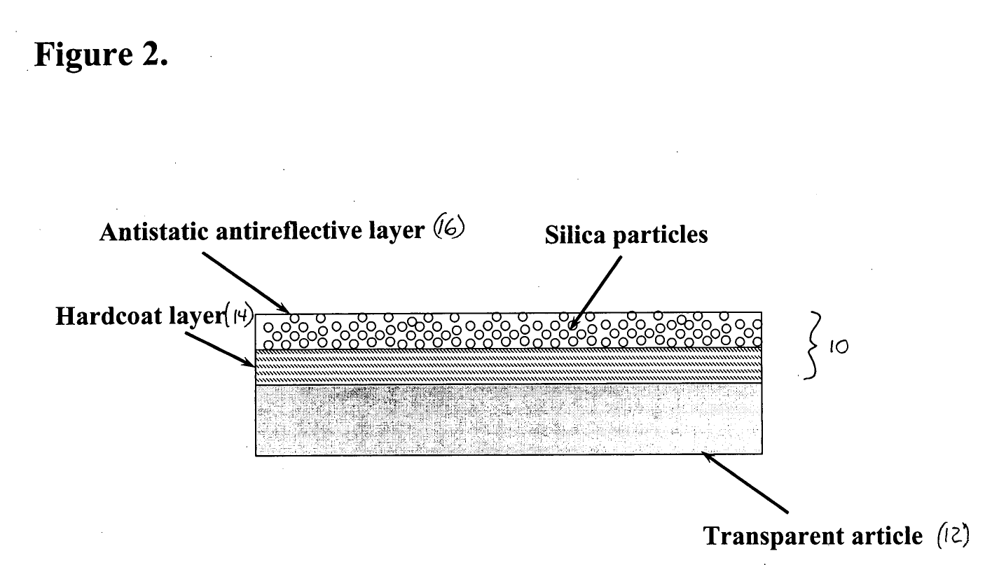

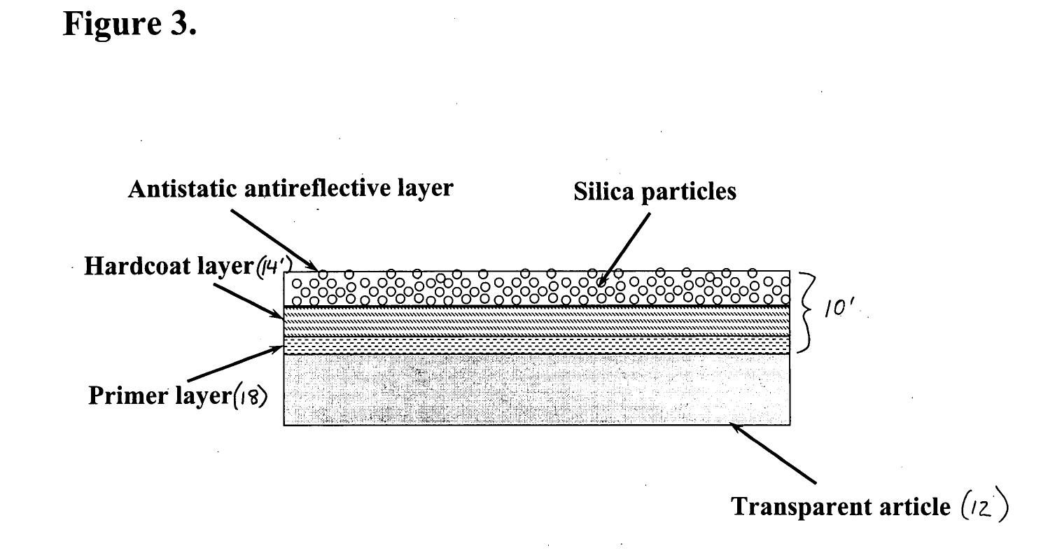

One embodiment of the antistatic antireflective coating is schematically depicted in FIG. 2. The coating 10 includes two layers deposited onto the article 12: a first, inner layer 14, constituting a hard coat layer, and a second, outer layer 16, constituting an antistatic, antireflective layer. In an alternative embodiment, depicted schematically in FIG. 3, the antistatic antireflective coating 10′ further includes a primer layer 18 located between the article 12′ and the hard coat layer 14′. This primer layer provides a better adherence of the hard coat to the article surface. The hard coat layer is incorporated into the coating not only to provide abrasion resistance for the article, but also for the antireflective, antistatic layer. Deposition of the hard coat layer is carried out using a suitable liquid hard coat formulation. In general, there are two types of liquid formulations: thermally curable and radiation energy curable, particularly ultraviolet (UV)-curable formulations. Both types of hard coat formulations are within the scope of this invention. The thermally curable formulations may provide better abrasion resistance than do the UV-curable formulations. However, the UV-curable formulations can be cured at comparatively much faster rates, thereby decreasing production costs. The type of hard coat formulation suitable for this invention can be decided by considering abrasion resistance and production cost requirements of a particular article. Particularly suitable for this invention are hard coat formulations providing abrasion resistances of less than about 10 percent haze gain after 100 cycles, and more preferably less than about 7 percent haze gain after 100 cycles, according to the Taber test described below.

In addition to the abrasion-resistance requirement, the hard coat layer should have a refractive index closely matching that of the underlying article, to prevent the formation of interference fringes. Furthermore, the thickness of the hard coat layer preferably is in the range of 1 to 10 micrometers, to provide the described abrasion resistance. If the thickness is less than 1 micrometer, the hard coat layer might not provide an abrasion resistance level within the scope of this invention. On the other hand, if the thickness is more than 10 micrometers, the deposition of the hard coat layer may result in formation of cracks, surface non-uniformities, or the entrapment of bubbles, leading to degradation of the coating's mechanical and optical properties.

The preparation and deposition of a variety of hard coat formulations providing abrasion resistance and refractive index levels suitable for the coatings of this invention are well described in the prior-art. A few examples of such hard coat formulations are described in U.S. Pat. No. 4,478,876 to Chung, U.S. Pat. No. 5,493,583 to Lake, and U.S. Pat. No. 6,001,163 to Havey et al. Such formulations are commercially available from SDC Corporation, of Anaheim, Calif., or Red Spot Corporation, of Evansville, Ind. Commercial UV-curable formulations sold under trademarks MP1175UV, manufactured by SDC Corporation, and UVB510R6, manufactured by Red Spot Corporation, and a commercial thermally curable formulation sold under trademark MP1154D, are particularly suitable for depositing the hard coat layer of the present invention. Hard coat deposition and curing techniques and conditions described in the prior art, as well as in application sheets of the commercial formulations, can be applied to provide the hard coat layer of this invention.

Before the deposition of the hard coat layer, the surface of the article may be modified by techniques well described in the prior art. These techniques include corona discharge, chemical etching (particularly by use of a solution of NaOH with water), or deposition of a primer layer to increase adhesion of the hard coat layer to the article. A commercial formulation sold under trademark PR1133, by SDC Corporation, is particularly suitable to deposit the primer layer for the thermally curable MP1154D formulation.

The antistatic, antireflective layer comprises essentially hydrolyzed silica. The sol-gel solution, which is used to deposit this layer, is prepared by reacting at least one hydrolyzable organo-metallic compound of silicon with water (preferably dionized water), and by adding silica particles. Suitable organo-metallic compounds are tetrafunctional silanes, represented by the formula, Si(OR¹)₄, where R¹ is H, an alkyl group containing from 1 to 5 carbon atoms and ethers thereof. Mixtures of tetrafunctional silanes also can be used in preparation of the sol-gel solution. Examples of tetrafunctional silanes are tetramethyl orthosilicate, tetraethyl orthosilicate, tetrapropyl orthosilicate, tetraisopropyl orthosilicate, tetrabutyl orthosilicate, tetraisobutyl orthosilicate, tetrakis(methoxyethoxy) silane, tetrakis(methoxypropoxy) silane, tetrakis(ethoxyethoxy) silane, tetrakis(methoxyethoxyethoxy) silane, tri(methoxyethoxy) silane, dimethoxydiethoxysilane, triethoxymethoxysilane, poly(dimethoxysilane), poly(diethoxysilane), poly(dimethoxydiethoxysilane), tetrakis(trimethoxysiloxy) silane, tetrakis(triethoxysiloxy) silane, and mixtures thereof. Preferred tetrafunctional silanes are tetramethyl orthosilicate, tetraethyl orthosilicate, tetrapropyl orthosilicate, tetraisopropyl orthosilicate, and mixtures thereof. The most preferred tetrafunctional silane is tetraethyl orthosilicate, Si(OC₂H₅)₄.

The sol-gel solution can further include at least one catalyst to accelerate the hydrolysis reaction of the silicon compound(s) with water. This catalyst is selected from the group consisting of hydrochloric acid (HCl), nitric acid (HNO₃), sulfuric acid (H₂SO₄), acetic acid (CH₃CO₂H), hydrofluoric acid (HF), and mixtures thereof. HCl is most preferred.

This solution can preferably further include at least one solvent, to increase the miscibility of the silicon compound with the water, to dilute the solution to control the thickness of the antistatic antireflective layer, and/or to chemically etch the surface of the coated article to increase adhesion. The solvents suitable for inclusion in the solution are alcohols, glycols, ethers, glycol ethers, ketones, esters, and glycolether acetates. Examples of such solvents are methanol, ethanol, propanol, isopropanol, butanol, isobutanol, secondary butanol, tertiary butanol, cyclohexanol, pentanol, octanol, decanol, di-n-butylether, ethylene glycol dimethyl ether, propylene glycol dimethyl ether, propylene glycol methyl ether, dipropylene glycol methyl ether, tripropylene glycol methyl ether, dipropylene glycol dimethyl ether, tripropylene glycol dimethyl ether, ethylene glycol butyl ether, diethylene glycol butyl ether, ethylene glycol dibutyl ether, ethylene glycol methyl ether, diethylene glycol ethyl ether, diethylene glycol dimethyl ether, ethylene glycol ethyl ether, ethylene glycol diethyl ether, ethylene glycol, diethylene glycol, triethylene glycol, propylene glycol, dipropylene glycol, tripropylene glycol, butylene glycol, dibutylene glycol, tributylene glycol, tetrahydrofuran, dioxane, acetone, diacetone alcohol, methyl ethyl ketone, cyclohexanone, methyl isobutyl ketone, ethyl-acetate, n-propyl acetate, n-butyl acetate, propylene glycol methyl ether acetate, dipropylene glycol methyl ether acetate, ethyl 3-ethoxypropionate, ethylene glycol ethyl ether acetate, and mixtures thereof. The preferred solvent is selected from the group consisting of methanol, ethanol, iso-propanol, and mixtures thereof.

The general range of the molar composition considered to be suitable for the sol-gel solution used for depositing the antistatic, antireflective layer is 1 mole of the organo-metallic silicon compound, 2 to 6 moles of water, 0.05 to 1.0 mole of the catalyst, and 10 to 110 moles of the solvent. More preferred is a molar composition range of 1 mole of the silicon compound, 2 to 5 moles of water, 0.1 to 0.3 mole of the catalyst, and 20 to 40 moles of the solvent.

The sol-gel solution also includes silica particles, in a predetermined concentration, to provide the antistatic property. U.S. Pat. No. RE 37,183 to Kawamura et al. discloses, in comparative examples, that anti-glare silica coatings containing silica particles in a range of 0.01 to 1 mg/cm² do not have antistatic property. For this reason, the patent further discloses that these coatings need to consist essentially of at least one compound selected from electroconductive metal oxides and hygroscopic metal salts, to provide an antistatic property to the article.

The inventors have surprisingly found that coatings having an antistatic property can be obtained by having a hydrolyzed silica layer containing silica particles preferably in a range of 0.00015 to 0.01 mg/cm², more preferably in a range of 0.00015 to 0.002 mg/cm², and most preferably in a range of 0.0002 to 0.001 mg/cm². If the particle concentration is lower than 0.00015 mg/cm², or higher than 0.01 mg/cm², the hydrolyzed silica layer does not have an antistatic property.

The silica particles of the present invention have sizes preferably smaller than 1000 nm, more preferably in the range of 5 to 1000 nm, and most preferably in the range of 10 to 100 nm. These particles can be either spherical or irregular in shape. The particles all are sufficiently small that they are substantially invisible to the naked human eye, both when in the solution and when in the antistatic, antireflective layer. The particles also provide antiglare-type antireflective property. By maintaining the particle concentration within above preferred ranges, the particle concentration in the antistatic, antireflective layer can be adjusted to increase the antiglare-type antireflection level, or conversely to increase the transmittance level, without loosing the antistatic property. Furthermore, when the thickness of the antistatic, antireflective layer is controlled to provide a destructive interference-type antireflective property, the overall antireflective property of the coating further improves and becomes less dependent on the wavelength of incident light. That is, a flatter reflectance curve is thereby obtained, as compared to coatings having no particles.

The silica particles may be in the form of a dry powder or a colloidal solution, and they may be dispersed in the sol-gel solution using mechanical stirring or ultrasonication. The silica particles also may be treated with dispersion agents such as aminopropyl trimethoxysilane, glycidoxypropyl trimethoxysilane, acryloxypropyl trimethoxysilane, methacryloxypropyl trimethoxysilane, trimethyl ethoxysilane, trimethyl methoxysilane, and mixtures thereof. This treatment may be done to increase dispersibility of particles within the sol-gel solution. The treatment also increases stability of the sol-gel solution.

The chemical compounds and silica particles described above are mixed in a suitable container, at a room temperature varying in the range of 20 to 35° C. During mixing, the organo-metallic compound of silicon is hydrolyzed through well-known hydrolysis and condensation polymerization reactions. The sol-gel solution then is filtered and transferred to a suitable plastic container to be used for the coating process.

Before deposition of the antistatic, antireflective layer, the surface of the article which has been pre-coated with the hard coat layer is modified by chemical etching or by corona discharge. Chemical etching solutions, preferably prepared by dissolution of NaOH and/or KOH with water, can be used to modify the surface of the hard coat layer. This surface modification increases the adhesion level of the antistatic antireflective layer with the hard coat layer.

The sol-gel solution can be deposited onto the article using any suitable coating technique commonly known in the industry, for example those described in a publication entitled “Antireflection Coatings Made by Sol-Gel Processes”, Solar Energy Materials and Solar Cells, Volume 68 (2001), pages 313 to 336, by Dinguo Chen. These coating techniques include dip-coating, spin-coating, roll-coating, flow-coating, and meniscus-coating. Spray-coating is less preferable, because it sometimes can be difficult to obtain uniform coatings using this technique. As described in U.S. Pat. No. RE 37,183 to Kawamura et al., coatings prepared by a spray-coating technique generally are thicker at the periphery than at the center. This non-uniformity can yield coatings providing poorer antireflective and antistatic properties.

In the dip-coating technique, the article is clamped to a cantilevered arm and dipped into the plastic container containing the sol-gel solution. The plastic container and the cantilevered arm are enclosed within a chamber having controlled humidity. It has been found that the humidity within the chamber must be precisely controlled, to ensure the depositing of transparent, defect-free coating layers. The relative humidity within the chamber preferably is controlled to be in the range of 20 to 40 percent. A higher humidity can cause the formation of defects in the deposited layer, visible to the eye. The temperature within the chamber preferably is maintained in the range of 15 to 30° C.

In the dip-coating technique, a drive system moves the cantilevered arm and the transparent article down and up along a vertical or inclined axis. The range of motion must be sufficient to dip the article fully into, and out of, the plastic container that carries the solution. The antistatic, antireflective layer is deposited by lowering the cantilevered arm and the article at a predetermined speed into the plastic container. After remaining submerged for a brief time period, the article is withdrawn from the solution at a predetermined speed. The drive system includes a suitably programmed computer, for precisely controlling the withdrawal speed of the arm and the article, so as to control the thickness of the layer being deposited. In general, slow withdrawal speeds yield thinner coating layers. The withdrawal speed preferably is less than 1.0 cm/second, and more preferably is less than 0.25 cm/second.

The level of reflection for the destructive interference-type antireflective coating critically depends on the coating's refractive index and on the coating's thickness. The composition of the sol-gel solution affects both of these parameters. The withdrawal speed yielding the desired level of reflection is determined empirically by preparing a number of coatings, each having an antistatic antireflective layer deposited at a different withdrawal speed, and by then measuring the antireflective property of each coating. The withdrawal speed yielding the best antireflective property is then selected to produce the antistatic antireflective layer.

Following the deposition of the antistatic antireflective layer, the coated article is dried at ambient temperature, in ambient air, for a time duration preferably less than 30 minutes and more preferably in the range of 5 to 10 minutes. The coated article then is thermally treated. The drying and the thermal treatment cause evaporation of residual organics from the antistatic, antireflective layer, and completion of the sol-gel reactions, to yield a solid film having some residual porosity and mechanical strength.

The thermal treatment should be carried out in a controlled humidity atmosphere, to provide the desired antistatic property. The partial pressure of water, PH_{2O}, expressed in units of kPa, of the controlled humidity atmosphere preferably satisfies the following inequality:
P_{H}_{₂}_{O}≧0.09+0.05T (Equation 1)
where T is temperature, in degrees C.

For example, at a thermal treatment temperature of about 20° C., the partial pressure of water should be at least 1.09 kPA, and at about 85° C. the partial pressure of water should be at least 4.34 kPa.

In one example of the method of the invention, the thermal treatment is carried out in a single step. In this example, the oven is maintained at an initial temperature in the range of 15 to 30° C., to avoid a thermal shock to the coated article when it is first placed in the oven. A failure to avoid the thermal shock can lead to the formation of cracks in the deposited layer. Thereafter, the oven temperature is increased to the thermal treatment temperature at a controlled, uniform heating rate, preferably less than 15° C./minute. The temperature of the thermal treatment preferably is in the range of 80 to 200° C., more preferably in the range of 100 to 140° C., and most preferably about 120° C. The time duration of the thermal treatment preferably is in the range of 10 minutes to 10 hours, more preferably in the range of 1 to 4 hours, and most preferably about 2 hours. Finally, the oven temperature is decreased to the initial temperature, again at a controlled uniform rate of less than 15° C./minute, to avoid thermal shock. During the thermal treatment, the atmosphere of the oven is replaced with a controlled humidity atmosphere, to provide the water partial pressure level defined above by Equation 1. This replacement can be initiated at any time during the thermal treatment process. However, the replacement should be continued for a time period sufficient to provide the coating with the desired antistatic property. The time duration of thermal treatment in the controlled humidity atmosphere (i.e., the humidity treatment time) can be determined empirically. The humidity treatment time decreases with increasing humidity treatment temperature. The total thermal treatment time duration can be equal to or longer than the humidity treatment time.

In another example of the method of the invention, the thermal treatment is achieved in two separate steps: a first step carried out with no controlled humidity atmosphere, and a subsequent second step carried out in a controlled humidity atmosphere. This provides the desired antistatic property.

In the first step, the oven is maintained at an initial temperature in the range of 15 to 30° C., to avoid a thermal shock to the coated article when it is first placed in the oven. A failure to avoid the thermal shock can lead to the formation of cracks in the deposited layer. Thereafter, the oven temperature is increased to a thermal treatment temperature, at a controlled uniform heating rate, preferably less than 15° C./minute. The thermal treatment temperature preferably is in the range of 80 to 200° C., more preferably in the range of 100 to 140° C., and most preferably about 120° C. The time duration of the thermal treatment preferably is in the range of 10 minutes to 10 hours, more preferably in the range of 1 to 4 hours, and most preferably about 2 hours. Finally, the oven temperature is decreased back to the initial temperature, again at a controlled, uniform rate of less than 15° C./minute, to avoid thermal shock.

In the second step, the oven is maintained at an initial temperature in the range of 15 to 30° C., to avoid a thermal shock to the coated article when it is first placed in the oven. A thermal shock can lead to the formation of cracks in the deposited layer. The oven temperature then is increased to the second thermal treatment temperature, again at a controlled, uniform heating rate, preferably less than 15° C./minute. The second thermal treatment temperature preferably is in the range of 15 to 140° C. and more preferably in the range of 20 to 120° C. Finally, the oven temperature is decreased back to the initial temperature, again at a controlled, uniform rate of less than 15° C./minute, to avoid thermal shock. During the second thermal treatment, the thermal treatment atmosphere is replaced with a controlled humidity atmosphere, to provide the water partial pressure level defined above in Equation 1. This replacement can be initiated at any time during the second thermal treatment step. However, the replacement should be continued for a time period sufficient to provide the coated article with the desired antistatic property. The time duration of the humidity treatment can be determined empirically. The humidity treatment time decreases with increasing temperature. The total thermal treatment time can be equal to or longer than the second humidity treatment time.

The thermal treatment atmosphere can comprise air, nitrogen, helium, argon, and mixtures thereof. Air is the most preferred thermal treatment atmosphere.

The method of the present invention can be better understood by way of the following illustrative examples.

### EXAMPLE 1

This example illustrates a preferred aspect of the method of the present invention. In this example, a two-layer antistatic, antireflective coating is deposited onto a polymethyl methacrylate(PMMA) panel. The first layer of the coating is a hard coat layer, to provide abrasion resistance to the coated panel. The second layer of the coating is a hydrolyzed silica layer, to provide an antistatic, antireflective property to the coated panel.

A commercial flat PMMA panel having a length of 40 cm, a width of 15 cm, and a thickness of 2 mm, sold under the trademark Shinkolite L, by Mitsubishi Rayon Corporation, of Tokyo, Japan, is coated. This panel is initially cleaned as follows. First, an adhesive paper used to protect the PMMA panel is removed. The bare panel then is cleaned in an ultrasonic bath, using detergent solutions, and thoroughly rinsed using deionized water. The wet, cleaned panel then is dried under a hot air flow, followed by an ionized airflow to avoid static charge build up.

A first layer is coated onto the cleaned panel using a dip-coating technique using a commercial UV-curable hard coat solution sold under the trademark UVB510R6, by Red Spot Corporation. This solution is filtered and transferred to a suitable dip coating tank. The coating is carried out in a class 10,000 clean room at about 20° C. and about 50 percent relative humidity. The panel is clamped to a vertically movable arm and lowered into the hard coat solution. The panel is kept submerged in the solution for about 10 seconds. The panel then is withdrawn from the solution at a speed of about 0.25 cm/s. The wet coat then is dried in air for about 5 minutes. The dried coating then is completely cured in a UV oven, using a UV dosage of about 10.2 J/cm². This coating step provides the hard coat layer on the panel.

The hydrolyzed silica solution used to deposit the second layer is prepared as follows. In a 10-gallon polyethylene container, about 6,441.4 grams of tetraethyl orthosilicate or Si(OC₂H₅)₄, sold under the trademark Silbond AG, by Silbond Corporation, of Weston, Mich., is mixed with about 3,783.0 grams of a reagent-grade ethyl alcohol, sold under the trademark A995-4, by Fisher Scientific, of Tustin, Calif. This first mixture is stirred using a magnetic stirrer for about 10 minutes at about 200 rpm rotating speed. In a separate 1 gallon polyethylene container, about 130.0 grams of hydrochloric acid (HCl) sold under the trademark A144-500, by Fisher Scientific, is mixed with about 1,127.7 grams of deionized water. This second mixture is stirred using a magnetic stirrer for about 5 minutes at about 200 rpm rotating speed. The second mixture then is added to the first mixture. The resulting third mixture is stirred using a magnetic stirrer for about 30 minutes at about 200 rpm rotating speed. The third mixture is diluted by adding about 16,219.9 grams of the reagent-grade ethyl alcohol. The resulting fourth mixture is stirred using a magnetic stirrer for about 5 hours at about 300 rpm rotating speed. The fourth mixture is filtered through 0.2 micrometer pore size Teflon filters and aged for about 15 hours by maintaining it at a room temperature of about 20° C. and a relative humidity of about 50 percent.

A fifth mixture is prepared in a separate container by mixing about 6.0 grams of hydrochloric acid (HCl) sold under the trademark A144-500, by Fisher Scientific, with about 200 grams of deionized water. A sixth mixture is prepared in a separate container by mixing about 735.2 grams of the reagent-grade ethyl alcohol, about 10.5 grams of silica particles sold under the trademark Aerosil R 972, by Degussa Corporation, of Akron, Ohio, and about 42.0 grams of the fifth mixture. The sixth mixture is placed in an ultrasonication apparatus and exposed to high-frequency sound waves of about 42 kHz, at a power level of about 1250 watts for about 100 minutes. Thereafter, a seventh mixture is prepared by adding about 3151.0 grams of the aged fourth mixture to the sixth mixture, and the ultrasonication is continued for about 30 additional minutes. Finally, an eighth mixture is prepared by adding about 23737.3 grams of the fourth mixture to the seventh mixture. The eighth mixture is stirred using a magnetic stirrer for about 30 minutes at about 200 rpm rotating speed.

The eighth mixture is used as a hydrolyzed silica solution to coat the second layer. Before application of the second layer, the panel coated with the first (i.e., hard coat) layer is etched by submerging it in about 5 percent sodium hydroxide (NaOH) solution for about 3 minutes and then cleaning the etched panel using deionized water and ultrasonication. This layer is coated by the dip-coating technique in a class 10,000 clean room at about 20° C. and about 50 percent relative humidity. The panel is clamped to a vertically movable arm and lowered into the hydrolyzed silica solution. The panel is kept submerged in the solution for about 10 seconds, and it is then withdrawn at a speed of about 0.10 cm/second. The wet coat is then dried in air for about 10 minutes. The dried coating is placed in an electrical heating oven at about 20° C. The thermal treatment of this coating is achieved in two steps. In a first step, the oven temperature is raised to a first thermal treatment temperature of about 120° C. within about 10 minutes. The coating is completely cured by maintaining the panel at this temperature for about 2.0 hours. Finally, the oven temperature is decreased back to the initial temperature, at a rate of less than 15° C./minute. In the second thermal treatment step, the panel is maintained at second thermal treatment temperature of about 20° C. in controlled humidity air, having about 1.17 kPa partial pressure of water vapor, for a predetermined time described below.

The panel coated with the first (i.e., hard coat) layer and the second (i.e., antistatic, antireflective) layer is analyzed using the following test methods.

The surface resistivity of the coated panel is determined by following the U.S.A. standard ASTM D257-78 and by using equipment manufactured by Prostat Corporation, of Bensenville, Ill. The equipment comprises a concentric ring fixture (Model PRF-911) as probe electrodes and a megaohmeter (Model PRS-801), which can automatically determine the required testing voltage. A test voltage of about 100 volts is applied to the sample. The electrification period, also automatically determined by the equipment, varies in the range of 8 to 13 seconds. The conversion factor for converting surface resistance (Ω) to surface resistivity (Ω/□) is 10. The surface resistivity measurements are carried out at a relative humidity in the range of 30 to 50 percent, at a room temperature of about 20° C.

An electrostatic decay time measurement system, comprising electrostatic fieldmeter model number PFM-711A, electrostatic charging source model number PCS-730, and static decay timer model number PDT-740B, manufactured by Prostat Corporation, is used to measure the static decay time of the coated panel. The testing procedure described in U.S.A. Federal Test Standard 101C, Method 4046.1, as modified and described in EIA-541 is followed. The coated panel is mounted between two electrodes within a Faraday cage. Six tests are performed, by applying an initial electrical charge of about 1,000 volts to the electrodes and measuring the time elapsed to decay the electrical charge below about 100 volts. The average of six decay times is considered to be the coated panel's static decay time. The static decay time measurements are carried out at a relative humidity in the range of 30 to 50 percent, at a room temperature of about 20° C.

The static decay time of the coated panel prepared in this example, measured immediately after the first thermal treatment, is about 4.7 seconds. After the second thermal treatment for about 1 day in air humidified with about 1.17 kPa partial pressure of water vapor, the static decay time reduces to below 2 seconds and the surface resistivity of the coated panel reaches 1.90×10⁹ Ω/□. Continuing the second thermal treatment for about 5 days under same humidity level further reduces the static decay time to 1.6 seconds and for about 10 days to 1.1 seconds.

These surface resistivity and electrostatic decay time measurements show that the coated panel prepared in this example has an antistatic property within the scope of the invention after the panel has been thermally treated in a controlled humidity atmosphere. The antistatic property improves with further thermal treatment in the controlled humidity atmosphere.

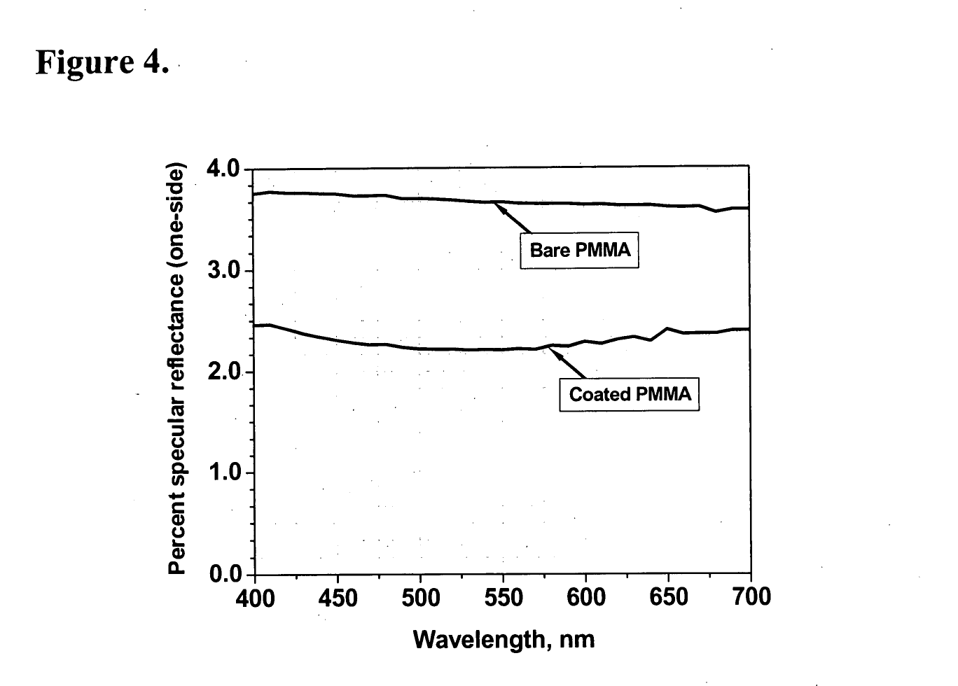

Reflectance of the coated panel is determined in a wavelength range of about 400 to about 700 nm using a spectrophotometer, model number UltraScan XE, manufactured by Hunter Lab, of Reston, Va. The reflectance level of one surface of the coated panel prepared in this example is shown in FIG. 4. The reflectance level of one surface of a panel having no coating (i.e., bare PMMA), as measured using the same procedures, also is shown in FIG. 4. These reflectance measurements indicate that the coated panel prepared in this example has antireflective properties within the scope of the invention.

The abrasion resistance of the coated panel is determined by the Taber Test following a U.S.A. standard ASTM D-4060 and using an abrader, model number 5130, manufactured by Taber Industries, of North Tonawanda, N.Y. The Taber abrasion test is performed on each sample using two CS10F abrader wheels, with about 500 grams of load per wheel. The sample is abraded by rotating the sample under the wheels for 100 cycles. Haze of the coated panel, both before and after the abrasion, is measured using a hazemeter, designed according to U.S.A. standard ASTM D-4039 and calibrated using haze standards model number HB-4745, manufactured by BYK-Gardner, of Columbia, Md. The percent difference (i.e., haze gain or percent ΔH) between these haze values determines the panel's abrasion resistance level. The haze gain of the coated panel prepared in this example is measured to be about 6.0 percent. The haze gain of the bare PMMA, as measured using the same procedure, is about 36.6 percent. These haze measurements indicate that the coated panel prepared in this example has an abrasion resistance property within the scope of the invention.

The adhesion of the coating is tested by following a cross-cut tape adhesion test described in a Japanese Industrial Standard JIS K 5600-5-6. The adhesion of the coated panel is determined to be Y1. This is an acceptable level of adhesion, within the scope of the invention.

The above test results show that the coating deposited on the panel in this example has the antistatic property, good antireflective property, and good abrasion resistance and adhesion.

### COMPARATIVE EXAMPLE 1

A coated panel is prepared and analyzed in the same manner as in EXAMPLE 1, except that the first layer is not etched using the NaOH solution, as described in EXAMPLE 1. The adhesion of the coated panel in this example is determined to be Y4, which indicates that the coating does not have good adhesion.

Taken together, EXAMPLE 1 and COMPARATIVE EXAMPLE 1 demonstrate that the first (hard-coat) layer should be etched with the NaOH solution to obtain good adhesion.

### EXAMPLE 2

A coated panel is prepared and analyzed in the same manner as in EXAMPLE 1, except that the first layer is deposited by using a commercial UV-curable hard coat formulation sold under the trademark MP1175UV, by SDC Corporation.

The static decay time of the coated panel, measured immediately after the first thermal treatment, is 2.4 seconds. Continuing the second thermal treatment for about 1 day reduces the static decay time to about 1.4 seconds, for about 5 days to about 1.8 seconds, for about 10 days to about 0.9 seconds, and for about 15 days to 1.7 seconds. The coated panel's reflectance is measured to be about the same as that obtained for the coated panel represented in FIG. 4. The haze gain is measured to be about 2.1 percent, and the adhesion is measured to be

Above test results shows that the coating deposited on the panel in this example has the antistatic property, good antireflective property, and good abrasion resistance and adhesion.

### COMPARATIVE EXAMPLE 2

A coated panel is prepared and analyzed in the same manner as in EXAMPLE 2, except that there are no silica particles in the sixth mixture during the preparation of hydrolyzed silica solution.

The static decay time of the coated panel, measured immediately after the first thermal treatment, is 9.3 seconds. Continuing the thermal treatment for about 1 day reduces the static decay time to about 3.8 seconds, for about 5 days to about 3.3 seconds, for about 10 days to about 3.6 seconds, and for about 15 days to about 4.9 seconds. These results indicate that the coated panel prepared in this example does not have the antistatic property.

Taken together, EXAMPLE 2 and COMPARATIVE EXAMPLE 2 demonstrate that the hydrolyzed silica solution should contain silica particles to provide the antistatic property.

### COMPARATIVE EXAMPLE 3

A coated panel is prepared and analyzed in the same manner as in EXAMPLE 1, except that the hard coat layer is not deposited onto the panel. Thus, the coated panel in this example includes only one layer, which is deposited using the hydrolyzed silica solution described in EXAMPLE 1.

The haze gain of this coated panel after the Taber test is measured to be 31.0 percent. An eye inspection of the as-abraded panel also indicates that the coating peels off of the surface. This result indicates that the coated panel prepared in this example does not have good abrasion resistance and adhesion.

Taken together, EXAMPLES 1 and 2 and COMPARATIVE EXAMPLES 1 and 3 demonstrate that the hard coat layer deposited as a first layer and etched by the NaOH solution provides the desired abrasion resistance and the adhesion within the scope of the invention.

### EXAMPLE 3

A coated panel is prepared and analyzed in the same manner as in EXAMPLE 1, except that the first layer is deposited using a commercial thermally curable hard coat formulation sold under the trademark MP1154D, by SDC Corporation, described as follows. First, a primer solution sold under the trademark PR-1133, by SDC Corporation, is deposited on a cleaned PMMA panel by dip-coating at a withdrawal speed of about 0.17 cm/seconds and by drying the wet panel under ambient conditions for about 30 minutes. The dried panel then is coated with MP1154D by dip-coating at a withdrawal speed of about 0.25 cm/second and cured in an oven at about 115° C. for about 3 hours. Finally, the antistatic antireflective layer is deposited onto this hard coat layer and the coating is tested in the same manner as in EXAMPLE 1.

The surface resistivity and the electrostatic decay time of the coated panel prepared in this example are measured to be less than 1×10¹² Ω/□ and less than 2 seconds, respectively, after the coated panel is subjected to the second thermal treatment for at least 1 day. The reflectance of the coated panel is measured to be about the same as that obtained for the coated panel represented in FIG. 5. The haze gain is measured to be less than 6 percent, and the adhesion is measured to be Y1.

### EXAMPLE 4

A coated panel is prepared and analyzed in the same manner as in EXAMPLE 1, except that it is subjected to second thermal treatment step by placing it in an oven at about 20° C., heating the oven to about 45° C. within about 10 minutes, then replacing the air in the oven with air humidified at about 2.9 kPa partial pressure of water vapor, and then maintaining the panel at about 45° C. in the humidified air for about 45 minutes. Finally, the oven temperature is decreased back to the initial temperature, at a rate of less than 15° C./minute.

The surface resistivity and the electrostatic decay time of the coated panel prepared in this example are measured to be less than 1×10¹² Ω/□ and less than 2 seconds, respectively, after the second thermal treatment step described above. The reflectance of the coated panel is measured to be about the same as that obtained for the coated panel represented in FIG. 5. The haze gain is measured to be less than 10 percent, and the adhesion is measured to be Y1.

### EXAMPLE 5

A coated panel is prepared and analyzed in the same manner as in EXAMPLE 1, except that it is subjected to the second thermal treatment step by placing the coated panel in an oven at about 20° C., heating the oven to about 85° C. within about 10 minutes, then replacing the air in the oven with air humidified at about 4.7 kPa partial pressure of water vapor, and then maintaining the panel at about 85° C. in the humidified air for about 20 minutes. Finally, the oven temperature is decreased back to the initial temperature, at a rate of less than 15° C./minute.

The surface resistivity and the electrostatic decay time of the coated panel prepared in this example are measured to be less than 1×10¹² Ω/□ and less than 2 seconds, respectively, after the second thermal treatment step described above. The reflectance of the coated panel is measured to be about the same as that obtained for the coated panel represented in FIG. 5. The haze gain is measured to be less than 10 percent, and the adhesion is measured to be Y1.

### EXAMPLE 6

A coated panel is prepared and analyzed in the same manner as in EXAMPLE 1, except that it is subjected to the second thermal treatment by placing it in an oven at about 20° C., heating the oven to about 95° C. within about 10 minutes, then replacing the air in the oven with air humidified at about 5.1 kPa partial pressure of water vapor, and then maintaining the panel at about 95° C. in the humidified air for about 5 minutes. Finally, the oven temperature is decreased back to the initial temperature, at a rate of less than 15° C./minute.

The surface resistivity and the electrostatic decay time of the coated panel prepared in this example are measured to be less than 1×10¹² Ω/□ and less than 2 seconds, respectively, after the second thermal treatment described above. The reflectance of the coated panel is measured to be about the same as that obtained for the coated panel represented in FIG. 5. The haze gain is measured to be less than 10 percent, and the adhesion is measured to be Y1.

Taken together, EXAMPLES 1, 4, 5, and 6 demonstrate that the time duration of the second thermal treatment can be decreased by increasing the temperature and the humidity level of the atmosphere.

### EXAMPLE 7

A coated panel is prepared and analyzed in the same manner as in EXAMPLE 1, except that it is subjected to only one thermal treatment step, in which the coated panel is placed in an oven at about 20° C., heating the oven to about 100° C. within about 10 minutes, then replacing the air in the oven with air humidified at about 5.5 kPa partial pressure of water vapor, and then maintaining the panel at about 100° C. in the humidified air for about 2 hours. The cured panel in this example was not subjected to the second thermal treatment step.

The surface resistivity and the electrostatic decay time of the coated panel prepared in this example are measured to be less than 1×10¹² Ω/□ and less than 2 seconds, respectively, after the thermal treatment step described above. The reflectance of the coated panel is measured to be about the same as that obtained for the coated panel represented in FIG. 5. The haze gain is measured to be less than 10 percent, and the adhesion is measured to be Y1.

Above test results shows that the coating deposited on the panel in this example has the antistatic property, good antireflective property, and good abrasion resistance and adhesion.

It should be appreciated from the foregoing description that the present invention provides an improved abrasion-resistant, antistatic, antireflective transparent coating, and a method for making it, in which the coating includes a hard coat underlayer and a antistatic, antireflective overlayer. The antistatic, antireflective overlayer consists essentially of hydrolyzed silica and silica particles having a size less than 1000 nm and a concentration in the range of 0.00015 to 0.01 mg/cm², and it is made using a sol-gel method including steps of (1) preparing a sol-gel solution preparing a sol-gel solution comprising a hydrolyzed organo-metallic compound of silicon and silica particles, (2) modifying the outer surface of the hard coat layer, (3) depositing the sol-gel solution onto the modified outer surface of the hard coat layer, and (4) thermally treating the article in an atmosphere having a controlled humidity, wherein the partial pressure of the water, P_{H}_{₂}_{O}, expressed in units of kPa, satisfies the following inequality:
P_{H}_{₂}_{O}≧0.09+0.05T
where T is temperature, in degrees C.

Although the invention has been described in detail with reference only to the preferred articles and methods describe above, those of ordinary skill in the art will appreciate that various modifications can be made without departing from the invention. Accordingly, the invention is defined only by the following claims.

1. An abrasion-resistant, antistatic, antireflective coating for a transparent article, comprising:
a. a hard coat layer deposited onto a surface of the transparent article; and
b. an antistatic, antireflective layer deposited onto the outer surface of the hard coat layer;
c. wherein the antistatic, antireflective layer consists essentially of hydrolyzed silica and silica particles having a size less than 1000 nm and a concentration in the range of 0.00015 to 0.01 mg/cm²;
d. wherein the antistatic, antireflective layer is deposited onto the outer surface of the hard coat layer using a sol-gel method comprising:
i. preparing a sol-gel solution comprising a hydrolyzed organo-metallic compound of silicon and silica particles,
ii. modifying the outer surface of the hard coat layer,
iii. depositing the sol-gel solution onto the modified outer surface of the hard coat layer, and
iv. thermally treating the article in an atmosphere having a controlled humidity, wherein the partial pressure of the water, PH₂O, expressed in kPa, satisfies the following inequality:
P_{H}_{₂}_{O}≧0.09+0.05T
where T is temperature, in degrees C.

2. An abrasion-resistant, antistatic, antireflective coating as defined in claim 1, wherein the hard coat layer has a thickness in the range of 1 to 10 micrometers.

3. An abrasion-resistant, antistatic, antireflective coating as defined in claim 1, wherein the hard coat layer has an abrasion resistance that is less than 10 percent haze gain, as measured by a Taber test after 100 cycles.

4. An abrasion-resistant, antistatic, antireflective coating as defined in claim 1, wherein the hard coat layer has an abrasion resistance that is less than 7 percent haze gain, as measured by a Taber test after 100 cycles.

5. An abrasion-resistant, antistatic, antireflective coating as defined in claim 1, and further comprising a primer layer interposed between the surface of the article and the hard coat layer.

6. An abrasion-resistant, antistatic, antireflective coating as defined in claim 1, wherein the silica particles have a size in the range of 5 and 1000 nm.

7. An abrasion-resistant, antistatic, antireflective coating as defined in claim 1, wherein the silica particles have a size in the range of 10 to 100 nm.

8. An abrasion-resistant, antistatic, antireflective coating as defined in claim 1, wherein the silica particle have a concentration in the range of 0.00015 to 0.002 mg/cm².

9. An abrasion-resistant, antistatic, antireflective coating as defined in claim 1, wherein the silica particle have a concentration in the range of 0.0002 to 0.001 mg/cm².

10. An abrasion-resistant, antistatic, antireflective coating as defined in claim 1, wherein the organo-metallic compound comprises tetrafunctional silanes.

11. An abrasion-resistant, antistatic, antireflective coating as defined in claim 1, wherein the organo-metallic compound is selected from the group consisting of tetramethyl orthosilicate, tetraethyl orthosilicate, tetrapropyl orthosilicate, tetraisopropyl orthosilicate, and mixtures thereof.

12. An abrasion-resistant, antistatic, antireflective coating as defined in claim 1, wherein the organo-metallic compound comprises tetraethyl orthosilicate.

13. An abrasion-resistant, antistatic, antireflective coating as defined in claim 1, wherein the sol-gel solution further comprises water.

14. An abrasion-resistant, antistatic, antireflective coating as defined in claim 1, wherein the sol-gel solution further comprises a catalyst selected from the group consisting of hydrochloric acid, nitric acid, sulfuric acid, acetic acid, hydrofluoric acid, and mixtures thereof.

15. An abrasion-resistant, antistatic, antireflective coating as defined in claim 1, wherein the sol-gel solution further comprises hydrochloric acid.

16. An abrasion-resistant, antistatic, antireflective coating as defined in claim 1, wherein the sol-gel solution further comprises a solvent selected from the group consisting of alcohols, glycols, ethers, glycol ethers, ketones, esters, and glycolether acetates.

17. An abrasion-resistant, antistatic, antireflective coating as defined in claim 1, wherein the sol-gel solution further comprises a solvent selected from the group consisting of methanol, ethanol, iso-propanol, and mixtures thereof.

18. An abrasion-resistant, antistatic, antireflective coating as defined in claim 1, wherein:
a. the sol-gel solution further comprises water, a catalyst, and a solvent; and
b. the sol-gel solution comprises 1 mole of the organo-metallic compound, 2 to 6 moles of the water, 0.05 to 0.1 moles of the catalyst, 70 to 110 moles of the solvent, and the silica particles.

19. An abrasion-resistant, antistatic, antireflective coating as defined in claim 1, wherein:
a. the sol-gel solution further comprises water, a catalyst, and a solvent; and
b. the sol-gel solution comprises 1 mole of the organo-metallic compound, 2 to 5 moles of the water, 0.1 to 0.3 moles of the catalyst, 20 to 40 moles of the solvent, and the silica particles.

20. A method for depositing an abrasion-resistant, antistatic, antireflective coating onto a surface of a transparent article, comprising:
a. depositing a hard coat layer onto the surface of the transparent article;
b. modifying the outer surface of the hard coat by corona discharge or chemical etching; and
c. forming an antistatic, antireflective layer onto the modified hard coat layer, wherein the antistatic, antireflective layer consists essentially of hydrolyzed silica and silica particles having a size less than 1000 nm and a concentration in the range of 0.00015 to 0.01 mg/cm², and wherein forming includes:
i. preparing a sol-gel solution comprising a hydrolyzed organo-metallic compound of silicon and silica particles,
ii. depositing the sol-gel solution onto the modified outer surface of the hard coat layer, and
iii. thermally treating the article in an atmosphere having a controlled humidity, wherein the partial pressure of the water, PH₂O, expressed in kPa, satisfies the following inequality:
P_{H}_{₂}_{O}≧0.09+0.05T
where T is a thermal treatment temperature, in degrees C.

21. A method as defined in claim 20, wherein modifying the outer surface of the hard coat layer is performed by chemical etching using a solution of NaOH and/or KOH with water.

22. A method as defined in claim 20, wherein modifying the outer surface of the hard coat layer is performed by chemical etching using a solution of NaOH with water.

23. A method as defined in claim 20, wherein the sol-gel solution is deposited onto the modified hard coat layer by a dip-coating method comprising:
a. submerging the article in the sol-gel solution; and
b. withdrawing the article at a withdrawal speed of less than 1.0 cm/second.

24. A method as defined in claim 20, wherein the sol-gel solution is deposited onto the modified hard coat layer by a dip-coating method comprising
a. submerging the article in the sol-gel solution; and
b. withdrawing the article at a withdrawal speed of less than 0.25 cm/second.

25. A method as defined in claim 20, and further comprising drying the antistatic, antireflective layer at ambient conditions for less than 30 minutes before the step of thermally treating.

26. A method as defined in claim 20, wherein the step of thermally treating further comprises:
a. placing the article in an oven maintained at a temperature in the range of 15° C. to 30° C.;
b. heating the oven to the thermal treatment temperature at a heating rate less than 15° C./minute;
c. maintaining the oven at the thermal treatment temperature for a predetermined time period; and
d. cooling the oven to a temperature in the range of 15 to 30° C., at a cooling rate of about 15° C./minute.

27. A method as defined in claim 20, wherein the step of thermally treating further comprises:
a. thermally treating the article in an oven at a predetermined thermal treatment temperature, for a predetermined thermal treatment time; and
b. introducing the controlled humidity atmosphere at any time during the step of thermally treating and continuing this introduction for a predetermined time period sufficient to provide the antistatic property to the article.

28. A method as defined in claim 27, the thermal treatment temperature is in the range of 80 to 200° C.

29. A method as defined in claim 27, the thermal treatment temperature is in the range of 100 to 140° C.

30. A method as defined in claim 27, wherein the thermal treatment temperature is about 120° C.

31. A method as defined in claim 27, wherein the thermal treatment time is in the range of 10 minutes to 10 hours.

32. A method as defined in claim 27, wherein the thermal treatment time is in the range of 1 to 4 hours.

33. A method as defined in claim 27, wherein the thermal treatment time is about 2 hours.

34. A method as defined in claim 20, wherein the step of thermally treating further comprises
a. initially thermally treating the article in an oven at a first predetermined thermal treatment temperature, for a predetermined first thermal treatment time period, with no controlled humidity atmosphere; and
b. subsequently thermally treating the article in an oven at a predetermined second thermal treatment temperature, and introducing the humid atmosphere at any time during such subsequent thermal treatment and continuing such introduction for a predetermined time period sufficient to provide the antistatic property to the article.

35. A method as defined in claim 34, wherein the first thermal treatment temperature is in the range of 80 to 200° C.

36. A method as defined in claim 34, wherein the first thermal treatment temperature is in the range of 100 to 140° C.

37. A method as defined in claim 34, wherein the first thermal treatment temperature is about 120° C.

38. A method as defined in claim 34, wherein the first thermal treatment time period is in the range of 10 minutes to 10 hours.

39. A method as defined in claim 34, wherein the first thermal treatment time period is in the range of 1 to 4 hours.

40. A method as defined in claim 34, wherein the first thermal treatment time period is about 2 hours.

41. A method as defined in claim 34, wherein the second thermal treatment temperature is in the range of 15 to 140° C.

42. A method as defined in claim 34, wherein the second thermal treatment temperature is in the range of 20 to 120° C.

43. A method as defined in claim 34, and further comprising depositing a primer layer onto the surface of the transparent article before depositing the hard coat layer.

44. A transparent article having a surface coated with the abrasion-resistant, antistatic, antireflective coating defined in claim 1.
